(19) United States
(12) Patent Application Publication
(10) Pub. No.: US 2003/0078703 A1
(43) Pub. Date: Apr. 24, 2003

(54) Cytometry analysis system and method using database-driven network of cytometers

(75) Inventors: Steven Potts, San Diego, CA (US); Louis J. Dietz, Mountain View, CA (US); Aaron B. Kantor, San Carlos, CA (US); Brenton R. Reynolds, Palo Alto, CA (US); Ian D. Walton, Redwood City, CA (US)

Correspondence Address: SWANSON & BRATSCHUN L.L.C., 1745 SHEA CENTER DRIVE, SUITE 330, HIGHLANDS RANCH, CO, 80129, US

(73) Assignee: SURROMED, INC., Mountain View, CA

(21) Appl. No.: 10/274,297

(22) Filed: Oct. 18, 2002

Related U.S. Application Data
(60) Provisional application No. 60/346,116, filed on Oct. 19, 2001.

(51) Int. Cl. G05D 1/00

(52) U.S. Cl. 701/1

(57) ABSTRACT

A database-driven cytometry network allows for acquisition, analysis, and viewing of large amounts of cytometry data from multiple cytometers. Data from multiple instruments are uploaded to a database, where combined compensation and calibration matrices are applied automatically to correct for both spectral overlap among acquisition channels and instrument-dependent variations. The resulting instrument-independent data are gated automatically using common template gates. A user at a client computer can view and perform statistical analyses on any desired subset of the gated data.

### CROSS-REFERENCE TO RELATED APPLICATIONS

This application claims the benefit of U.S. Provisional Application No. 60/346,116, “A Database-Driven Network of Cytometers,” filed Oct. 19, 2001, incorporated herein by reference.

### FIELD OF THE INVENTION

The present invention relates generally to biological measurement instrumentation and data processing. More particularly, it relates to a database-driven network of cytometers that facilitates high-throughput collection and analysis of large quantities of data.

### BACKGROUND OF THE INVENTION

Cytometry involves the classification and quantification of subsets of cells. Antibodies or other agents are tagged with fluorescent molecules and used to differentially label cells bearing particular molecules. Typically, multiple tags, distinguishable by emission wavelength, are each associated with a different antibody, and different antibodies can bind to a single cell. Optical measurements are taken of the individual cells (referred to as “events”) using a cytometer (e.g., a flow cytometer or laser scanning cytometer), a hardware device that measures the amount of fluorescence or reflected light from each cell event in one or more wavelength ranges. Different tag wavelengths are measured in different detection channels, and cell identities or characteristics can be determined from the optical measurements. Data for multiple parameters are collected on a cell-by-cell basis and stored, typically in list mode, for further analysis.

Often there are more than a dozen different measurements, known as dimensions, acquired on each cell event. As a result, cytometry is known in the scientific community as an extremely tedious data analysis field, requiring considerable amounts of a highly trained user's time to carry out cell typing. The amount of data produced in a traditional cytometry study can manageably be processed manually. Even in large cytometry facilities containing multiple cytometers, individual machines are typically operated by individual researchers for different studies. Each user standardizes assays and analyses on the individual instrument. There is no need to integrate the data collected in all of the studies, and the facility generally is not responsible for storing and maintaining the collected data. Instead, researchers analyze and copy their own data before leaving the facility, commonly storing data in individual data files and using spreadsheets for data processing.

Currently, new research paradigms are being developed to identify biological markers, measured biological characteristics correlated with normal biological processes, pathogenic processes, or pharmacological responses to therapeutic interventions. For example, a phenotype and biological marker identification system is disclosed in copending U.S. patent application Ser. No. 09/558,909, “Phenotype and Biological Marker Identification System,” filed Apr. 26, 2000, incorporated herein by reference. In such systems, enormous amounts of biological data are gathered in a high-throughput fashion and mined to discover novel markers and correlations. One component of this system is a cytometer or cytometers, which is used to measure hundreds of different cell populations, cell surface antigens, and soluble factors, potentially from thousands of different patients. The amount of data gathered in such a system is simply overwhelming to traditional methods of storing and processing cytometry data. New data-handling platforms and protocols are therefore needed.

Clinical and pre-clinical studies of disease and therapeutic intervention are often done at multiple, distant sites, each having its own cytometer. Existing data file management is not amenable to data transfer and collaboration among physically separated research sites. It would be highly desirable to have a method for collecting and processing data from the distant instruments in a consistent, automated, and streamlined manner. In some prior art cytometry software, a small database is used to store metadata and some experimental results. To the knowledge of the present inventors, however, there are no existing methods for integrating large numbers of cytometers.

There is a need, therefore, for methods to store, process automatically, and display large amounts of cytometry data from different cytometers in an efficient manner.

### SUMMARY OF THE INVENTION

Various embodiments of the present invention provide computer-implemented systems and methods for analysis and display of cytometry data. In some embodiments, data collected by a series of networked cytometers are uploaded to a database for automated processing and storage. The processed data can then be viewed and analyzed at client computers.

One embodiment of the present invention provides a method for analyzing cytometry data. Experimental data and associated metadata are transferred from one or more networked cytometry instruments to a database. Based on the metadata, instrument-dependent and experiment-dependent computations are automatically performed on the experimental data in the database, thereby generating instrument-independent data. Preferably, a combined compensation and calibration matrix is applied to the experimental data. Subsequently, based on the metadata, a gating scheme is automatically applied to the instrument-independent data to obtain gated data. The gated data are preferably evaluated to detect incorrect application of the gating scheme.

The instrument-independent or gated data can then be transmitted to one or more client computers for display to and analysis by a user. User input, such as a template gate or compensation matrix, can be received at the client computer. Preferably, processed data are displayed to the user at the client computer in dependence on received user input.

In an alternative embodiment, the present invention provides a method for analyzing cytometry data in which experimental data and associated metadata are obtained from at least two cytometry instruments. Based on the metadata, instrument-dependent and experiment-dependent computations are automatically performed on the experimental data, thereby generating instrument-independent data. Preferably, a combined compensation and calibration matrix is applied to the experimental data. Subsequently, based on the metadata, a gating scheme is automatically applied to the instrument-independent data to obtain gated data. Preferably, the gated data are evaluated to detect incorrect application of the gating scheme.

The instrument-independent or gated data can then be transmitted to one or more client computers for display to and analysis by a user. User input, such as a template gate or compensation matrix, can be received at the client computer. Preferably, processed data are displayed to the user at the client computer in dependence on received user input.

An additional embodiment of the present invention is a method for analyzing cytometry data in which experimental data and associated metadata are transmitted from at least two cytometry instruments to a database. Processed data, which are independent of the cytometry instruments and which can include gated data, are received from the database and displayed and analyzed according to user input.

A further embodiment of the present invention provides a program storage device accessible by a processor, tangibly embodying a program of instructions executable by the processor to perform method steps for the methods described above.

Another embodiment of the invention is a distributed computer system for acquiring and analyzing cytometry data, containing three elements in communication: a plurality of cytometry instruments, a database, and a plurality of client computers. The database stores experimental data, processed data, an instrument-dependent data correction, an experiment-dependent data correction, and an instrument-independent gating scheme. Processed data can be viewed and analyzed at the client computers.

Additionally, one embodiment of the invention provides a computer-readable medium storing a cytometry database for analyzing cytometry data. The database stores at least one instrument-dependent compensation and calibration scheme, such as a combined compensation and calibration matrix, and at least one instrument-independent gating scheme.

### BRIEF DESCRIPTION OF THE FIGURES

FIG. 1 is a block diagram of one embodiment of a distributed computer system for acquiring and analyzing cytometry data.

FIGS. 2A and 2B illustrate the application of a gating scheme to a two-dimensional cytometry plot, as known in the prior art.

FIGS. 3A and 3B illustrate a specific prior art gating scheme that is applied automatically in embodiments of the present invention.

### DETAILED DESCRIPTION OF THE INVENTION

Various embodiments of the present invention provide database-driven cytometry platforms. One embodiment includes a network of communicating cytometers, all in communication with a central database that stores information about the instruments, assays, and patients, as well as all of the collected and analyzed data. The database can facilitate automated data processing, thereby improving results and lowering analysis costs. The networked cytometers can exist within a single physical site or can be distributed throughout a geographic region that may be worldwide. In one embodiment, a network of client machines enables multiple users to access data stored in the database.

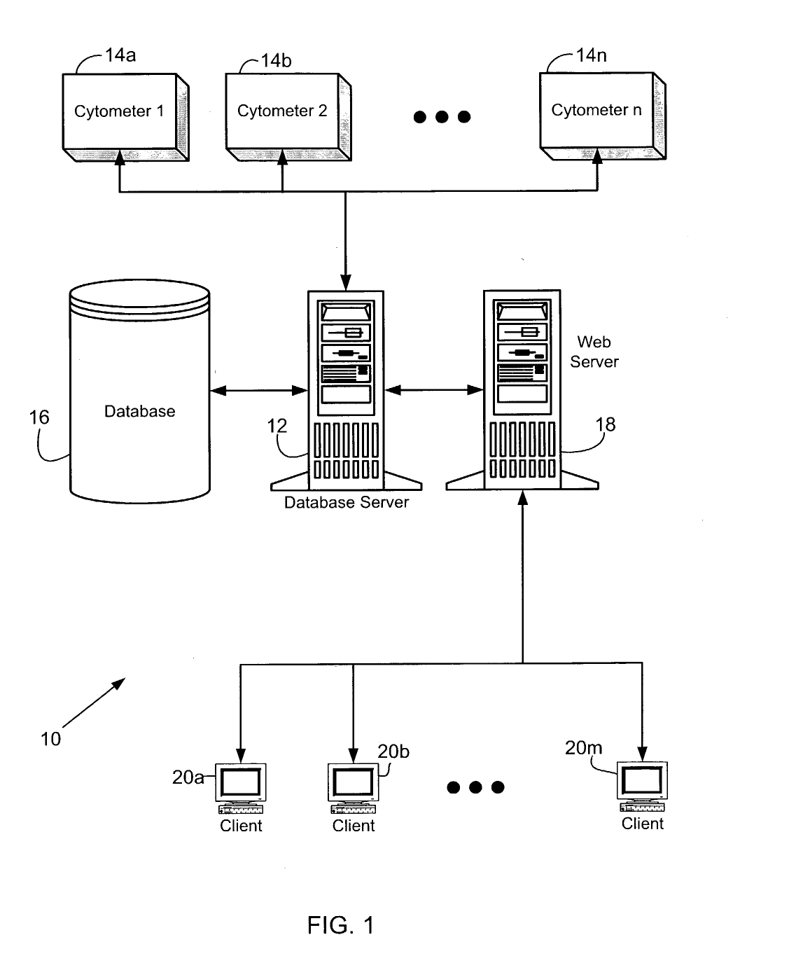

FIG. 1 is a block diagram of one embodiment of a cytometry system 10 of the present invention. The system 10 contains a database server 12 in communication with a plurality of cytometry instruments 14a-14n according to conventional protocols. Any number of cytometry instruments 14 can be included. The instruments 14 can be in the same physical location as the database server 12, all in a single physical location but different from that of the database server 12, or geographically distributed, potentially worldwide. Depending upon the particular locations of the cytometry instruments 14 and the database server 12, appropriate network connections are employed using conventional methods.

The database server 12 is also in communication with a database 16, such as an Oracle database, which is stored on a computer-readable medium (e.g., system memory or disk drive) and contains, for example, the following elements: experimental data obtained from the cytometry instruments 14; processed data; sample and assay metadata; experimental protocols; gating schemes; and data processing parameters such as compensation and calibration matrices or schemes (described below). The database can contain a subset of these elements or additional elements, depending upon the specific implementation. The database server 12 queries the database 16 using conventional methods and communication protocols to obtain the desired data.

The system 10 also contains a web server 18 in communication with the database server 12. The database server 12 and web server 18 can be implemented on a single server computer or on multiple server computers in communication. The web server 18 communicates with a plurality of client computers 20a-20m according to conventional protocols such as HTTP and TCP/IP. For example, the web server 18 and client computers 20 can be connected through the Internet, a Wide-Area Network (WAN), or a Local-Area Network (LAN), and any number of client computers 20 may be used. Depending upon security permissions, a user at a client computer 20 can access, view, and analyze the data stored in the database 16, for example, through a web-based analysis tool running on the client computer 20.

Methods of the invention are executed by processors of the database server 12, web server 18, and client computers 20 under the direction of computer program code stored within the respective machines. Using techniques well known in the computer arts, such code is tangibly embodied within a computer program storage device accessible by the processors, e.g., within system memory or on a computer readable storage medium such as a hard disk or CD-ROM. The methods may be implemented by any means known in the art. For example, any number of computer programming languages, such as Java, C++, or LISP may be used. Furthermore, various programming approaches such as procedural or object oriented may be employed. As will be apparent to those of skill in the art, the steps described herein are highly simplified versions of the actual processing performed by the client and server machines. It is to be understood that methods containing additional steps or rearrangement of the steps described are within the scope of the present invention, as are system architectures containing any number of server and client computers and cytometry instruments. Additionally, the database 16 may contain multiple smaller databases. Of course, as future developments occur in the fields of computer hardware, software, and communication methods, it is expected that such methods will be employed in embodiments of the present invention.

Each cytometry instrument 14 can be a conventional apparatus such as a flow cytometer, fluorescence-activated cell sorter, or laser scanning cytometer. Raw data are acquired by the instrument 14 as detected scattered light or fluorescence in each of the measured wavelength channels. Image analysis is performed on the data to arrive at a processed data set, which is typically stored temporarily as list mode data in XML format. As used herein, a data set refers to data acquired from a single sample. In one embodiment, one tabular row represents a single cellular event and contains light intensity values, e.g., scattered light intensity or fluorescence intensity, in a number of different wavelength channels for each cell event. At a specified time after all data have been acquired for a particular sample, the list mode data, referred to herein as experimental data, are transferred to the database server 12, along with metadata about the experimental data, for storage in the database 16. The upload can occur at any desired time, e.g., immediately after the data are collected, at specified time intervals, or upon user request. The data are stored locally within each instrument 14 before being uploaded to the database 16.

At a specified time after the experimental data are uploaded from one of the cytometers 14 to the database 16, the database server 12 performs computations on the experimental data to produce instrument-independent data. For example, the computations can be performed upon upload, at regular time intervals, or in response to a user request. Two types of computations can be performed, an instrument-dependent computation (or data correction) and an experiment- (or assay-) dependent computation (or data correction). Preferably, a single computation performed includes both the instrument-dependent and experiment-dependent computations. The computations are performed in dependence on the metadata associated with the experimental data. Metadata include any suitable descriptors or identifiers of the experimental data; for example, the metadata can include identifiers of the sample, sample type (e.g., whole blood), reagents (fluorescent tag and antibodies), subject, instrument, instrument calibration, experiment date and time, and study protocol, as well as text descriptions of the protocol and sample.

The experiment-dependent computation is related to the conventional application of compensation matrices to the list-mode data. This data transformation corrects or compensates the output of each wavelength channel for spectral overlap from multiple different fluorochromes. The resulting data have an intensity scale that is proportional to the amount of analyte on the cell, rather than the total fluorescence at a particular wavelength. Compensation matrices are known in the art and will not be described herein in detail. Each matrix is specific to the assay and reagents used, and the coefficients can be determined by measuring the fluorescence of each individual reagent at a particular instrument. Compensation matrices are stored in the database 16 and automatically applied to the experimental data upon upload (or at a different specified time) based on the metadata associated with the experimental data.

The instrument-dependent computation corrects for instrument-to-instrument variation in spectral response. Although the instruments 14 are typically calibrated to yield reproducible results using standard materials such as fluorescent beads or laser crystals, differences persist that prevent direct comparison of data across multiple instruments. For example, there are often slight differences in individual instrument components such as transmission spectra of optical filters or responses of detectors (e.g., photomultiplier tubes). A calibration matrix, analogous to the compensation matrix, is stored in the database 16 and automatically applied to the experimental data upon upload (or at a different specified time) to remove instrument-dependent features of the data.

In one embodiment, a combined compensation and calibration matrix is applied to the experimental data in a single step to obtain instrument-independent data. This combined matrix 1) corrects for spectral overlap among fluorescent tags and 2) corrects for optical differences among instruments. The combined matrix can be determined by measuring individual reagents and bead standards on each cytometry instrument 14a-14n. A number of different combined compensation and calibration matrices are stored in the database 16, each one specific to a particular instrument and assay (experiment). The correct matrix is applied to experimental data uploaded to the database based on the assay and instrument identifiers in the metadata associated with the experimental data. Application of this comprehensive matrix yields consistent data values across instruments and enables use and automation of a common set of subsequent data analyses, facilitating the use of the database 16 to store all data from multiple cytometers 14a-14n. Although the compensation and calibration data may not be represented in the form of a conventional matrix, it is to be understood that the terms “compensation matrix” and “calibration matrix” refer to any data or computations used to perform such corrections on the data. In general, the matrices and associated processing are referred to as compensation and calibration schemes.

After the experimental data have been processed to generate instrument-independent data, a gating scheme stored in the database 16 is applied automatically to the data, as determined by the assay type defined in the associated metadata. The results, referred to as gated data, are also stored in the database 16, and further statistics can be computed automatically if desired. Note that a single gating scheme can be applied to data acquired from different instruments at different sites, and user input is not required.

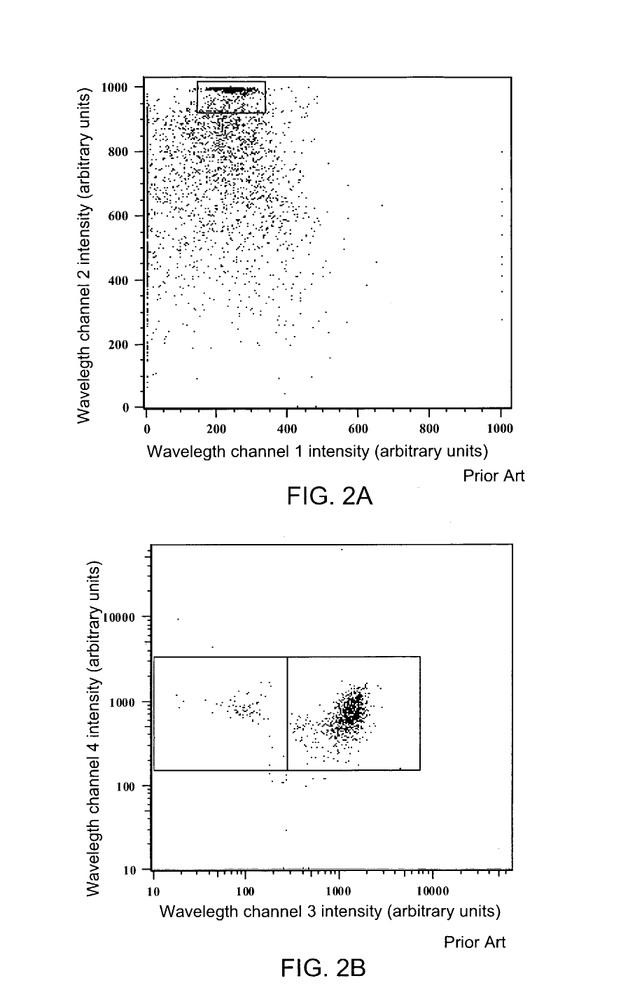

A gating scheme is a series of analytical steps used to divide cell events in a hierarchical fashion based on intensity levels in different wavelength channels. FIGS. 2A and 2B illustrate the application of a gating scheme to cytometry data plotted as a two-dimensional scatter plot, intensity in a first channel versus intensity in a second channel. Each point (or “dot”) corresponds to a single detected cell event. Boundaries or gates are drawn around clusters of points representing cell events with common characteristics. FIG. 2A illustrates a typical first step in a gating scheme, dividing detected events into actual cells and non-cells. The points within the gate shown are considered to correspond to a cell population, and the points outside to events that are not considered biological cells.

In the next step (FIG. 2B), the gated cluster is viewed in a different two-dimensional space, and gates are drawn around clusters of cells corresponding to particular subpopulations of cells. Each successive subpopulation can be viewed in a different two-dimensional space to facilitate further hierarchical subdivision into subpopulations.

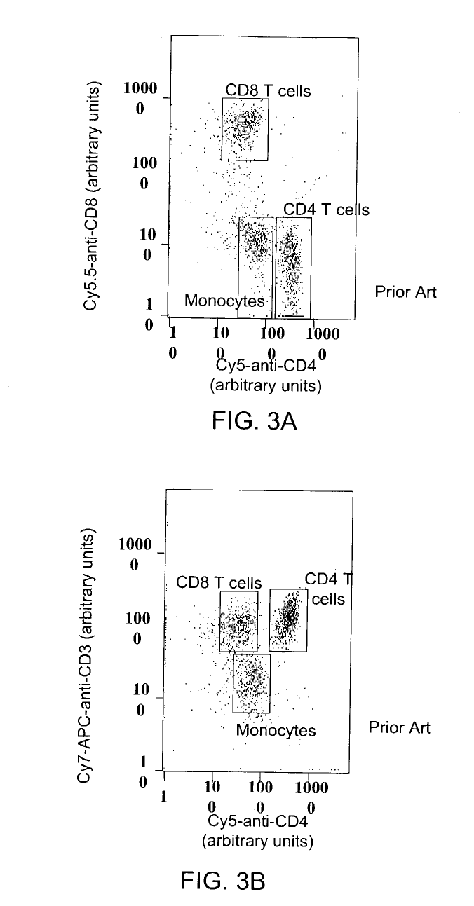

An example prior art gating scheme is illustrated in FIGS. 3A and 3B, which show data acquired from a three-color assay (i.e., three wavelength channels) of whole blood. The data in the figures have been compensated for spectral overlap and therefore represent intensity of the dye-antibody reagent on each cell. In this study, three different cell populations can be distinguished: helper (CD4⁺) T cells, which express the antigens CD3 and CD4; cytotoxic (CD8⁺) T cells, which express the antigens CD3 and CD8; and monocytes, which express low levels of CD4 but not CD3. The different antigens are labeled by fluorophore-conjugated antibodies Cy5-anti-CD4, Cy5.5-anti-CD8, and Cy7-APC-anti-CD3. Three populations of cells are indicated in the plots. Both populations of T cells express CD3, as shown in FIG. 3B, and are differentiated by their relative levels of CD4 and CD8 expression. Monocytes express neither CD3 nor CD8.

In some cases, the automatic gating schemes may be applied incorrectly. Some biological samples may have events that do not fit the common gates, for example, because of an error in conducting the assay or a biological factor (e.g., disease) that affects the cell populations in unpredictable ways. Additionally, absolute values of the various dimensions can shift over time because of instrument drift or gradual changes in fluidics or dye properties. In one embodiment, the database server 12 can automatically test the gates applied to each data set and flag those data sets to which the gates have been applied incorrectly. Any suitable method can be employed to detect incorrectly applied gates. In one method, the number of events (“counts”) falling within a particular gate can be monitored for a data set and a defined outlier search performed. A suitable measure of counts for the data set, such as a median, can be computed, and gates considered incorrectly applied when the gated population has a count value that is a threshold percentage away from the median. Alternatively, a cluster analysis can be performed near the gate boundary to determine whether clusters of events fall outside of the gate. After the gates have been flagged, a user can apply or devise a different gating scheme for the flagged data sets. Alternatively, the database server 12 can analyze the flagged data sets to determine a different gating scheme to be applied. In some cases, the metadata can contain instructions about an alternative gating scheme to be applied.

In addition to the experimental, instrument-independent, and gated data, compensation and calibration matrices, and gating schemes, the database 16 can store experimental protocols containing specific information about reagents, samples, patients, and instruments. One or more assays, each with multiple reagents, can be used in any given protocol. Typically, a single protocol contains information about multiple samples, patients, and instruments. An appropriate protocol or elements of a protocol is downloaded to individual cytometers before data acquisition begins.

A user at a client computer 20 can access the instrument-independent and gated data stored in the database 16 via its interaction with the web server 18. Data corresponding to large numbers of samples can be viewed simultaneously. In fact, in one embodiment of the invention, study-wide data analysis and mining can be performed. Preferably, the gated data can be viewed and analyzed at the client computer in two or three dimensions with an interactive web-based software program (e.g., a Java™ program). The user submits user input to the web server via the client computer to direct the viewing, sorting, grouping or other analysis of the data.

In one embodiment, the user can select the data to be viewed by criteria including, but not limited to, subject identifier, study protocol, sample draw identifier, assay, instrument, date, location, operator, or gated or ungated cell population. The user can also request the type of graph to be displayed, e.g., one-dimensional histogram or two- or three-dimensional scatter plot. In an additional embodiment, the user can view related statistics (counts and intensity) for a particular population. In another embodiment, data sets that were flagged for incorrect application of gates can be viewed and a different gating scheme applied. While viewing any of the data, the user can select to apply different gating schemes or compensation and calibration matrices to populations or data sets than those applied automatically. In another embodiment, if subsequent analysis such as cluster analysis or pattern recognition is to be performed, the user can select those data sets to be excluded from or included in such analysis. Reports can be generated at the user's request or automatically based on the metadata.

The web-based software implemented at the client computer 20 can also be used to design the original gating scheme. In this embodiment, the user constructs the gating scheme on a particular data set at the client computer 20 and uploads the scheme to the database 16 for storage. The new gating scheme is then applied automatically to data sets whose metadata matches conditions specified by the user in the gating scheme. Statistics can also be selected to be associated with each gating scheme.

It should be noted that the foregoing description is only illustrative of the invention. Various alternatives and modifications can be devised by those skilled in the art without departing from the invention. Accordingly, the present invention is intended to embrace all such alternatives, modifications, and variances that fall within the scope of the disclosed invention.

What is claimed is:

1. A method for analyzing cytometry data, comprising:
a) transferring experimental data and associated metadata from at least one cytometry instrument to a database;
b) based on said associated metadata, automatically performing an instrument-dependent computation and an experiment-dependent computation on said experimental data in said database to obtain instrument-independent data; and
c) based on said associated metadata, automatically applying a gating scheme to said instrument-independent data in said database to obtain gated data.

2. The method of claim 1, wherein step (b) comprises applying a combined compensation and calibration matrix to said experimental data.

3. The method of claim 1, further comprising detecting incorrect application of said gating scheme to said instrument-independent data.

4. The method of claim 1, further comprising transmitting said gated data to a client computer.

5. The method of claim 4, further comprising displaying said gated data at said client computer.

6. The method of claim 4, further comprising receiving user input at said client computer.

7. The method of claim 6, wherein said user input comprises a template gate.

8. The method of claim 6, wherein said user input comprises a compensation matrix.

9. The method of claim 6, further comprising displaying processed data in dependence on said user input.

10. A method for analyzing cytometry data, comprising:
a) obtaining experimental data and associated metadata from at least two cytometry instruments;
b) based on said associated metadata, automatically performing an instrument-dependent computation and an experiment-dependent computation on said experimental data to obtain instrument-independent data; and
c) based on said metadata, automatically applying a gating scheme to said instrument-independent data to obtain gated data.

11. The method of claim 10, wherein step (b) comprises applying a combined compensation and calibration matrix to said experimental data.

12. The method of claim 10, further comprising detecting incorrect application of said gating scheme to said instrument-independent data.

13. The method of claim 10, further comprising transmitting said gated data to a client computer.

14. The method of claim 13, further comprising displaying said gated data at said client computer.

15. The method of claim 13, further comprising receiving user input at said client computer.

16. The method of claim 15, wherein said user input comprises a template gate.

17. The method of claim 15, wherein said user input comprises a compensation matrix.

18. The method of claim 15, further comprising displaying processed data in dependence on said user input.

19. A method for analyzing cytometry data, comprising:
a) transmitting experimental data and associated metadata from at least two cytometry instruments to a database;
b) receiving processed data from said database, wherein said processed data are independent of said cytometry instruments; and
c) displaying said processed data.

20. The method of claim 19, wherein said processed data comprise gated data.

21. A program storage device accessible by a processor, tangibly embodying a program of instructions executable by said processor to perform method steps for a cytometry data analysis method, said method steps comprising:
a) obtaining experimental data and associated metadata from at least two cytometry instruments;
b) based on said associated metadata, automatically performing an instrument-dependent computation and an experiment-dependent computation on said experimental data to obtain instrument-independent data; and
c) based on said metadata, automatically applying a gating scheme to said instrument-independent data to obtain gated data.

22. The program storage device of claim 21, wherein step (b) comprises applying a combined compensation and calibration matrix to said experimental data.

23. The program storage device of claim 21, wherein said method steps further comprise detecting incorrect application of said gating scheme to said instrument-independent data.

24. The program storage device of claim 21, wherein said method steps further comprise transmitting said gated data to a client computer.

25. The program storage device of claim 24, wherein said method steps further comprise displaying said gated data at said client computer.

26. The program storage device of claim 24, wherein said method steps further comprise receiving user input at said client computer.

27. The program storage device of claim 26, wherein said user input comprises a template gate.

28. The program storage device of claim 26, wherein said user input comprises a compensation matrix.

29. The program storage device of claim 26, wherein said method steps further comprise displaying processed data in dependence on said user input.

30. A system for acquiring and analyzing cytometry data, comprising:
a) a plurality of cytometry instruments;
b) a database in communication with said cytometry instruments, said database storing experimental data, processed data, an instrument-dependent data correction, and experiment-dependent data correction, and an instrument-independent gating scheme; and
c) a plurality of client computers in communication with said database for viewing and analyzing said processed data.

31. A computer-readable medium storing a cytometry database for analyzing cytometry data, said cytometry database comprising:
a) at least one instrument-dependent compensation and calibration scheme; and
b) at least one instrument-independent gating scheme.
